(19) United States
(12) Patent Application Publication
(10) Pub. No.: US 2009/0126951 A1
(43) Pub. Date: May 21, 2009

(54) How to control forest fires through the use of fire-fighting helicopters

(76) Inventor: Won Wook Baek, (US)

Correspondence Address: Won Wook Baek, Apt 404, 11045 8th Ave NE, Seattel, WA, 98125-6130, US

(21) Appl. No.: 11/985,315

(22) Filed: Nov. 15, 2007

(51) Int. Cl. A62C 3/02

(52) U.S. Cl. 169/53

(57) ABSTRACT

The Typhoon Effect company—has a super-size fire helicopter, called the Typhoon Effect (V-3) which carries thousands of tons of water in a tank connected with a shower system. When the fire helicopter pours heavy showers over the forest fire, the heavy showers act as a typhoon. When this fire helicopter slowly comes down close to the forest fire, the effect of the rain and wind gets stronger, blowing the forest fire away, and then freezing it under the ignition point around the fire.

Finally, this process makes carbonic-acid gas production impossible, thereby helping terminate the forest fire. The fire helicopter stops declining and keeps a steady altitude of ±300 meters. This “low altitude” allows the firefighter to check the status of the fire by executing a “slow heading.”

### PURPOSE

The purpose of this article is to discuss how to prevent the loss of tremendous amounts of forests, homes, and property nationwide due to frequent dry season forest fires. In addition this article intends to explain how to help protect the Earth from the greenhouse effect.

### Description

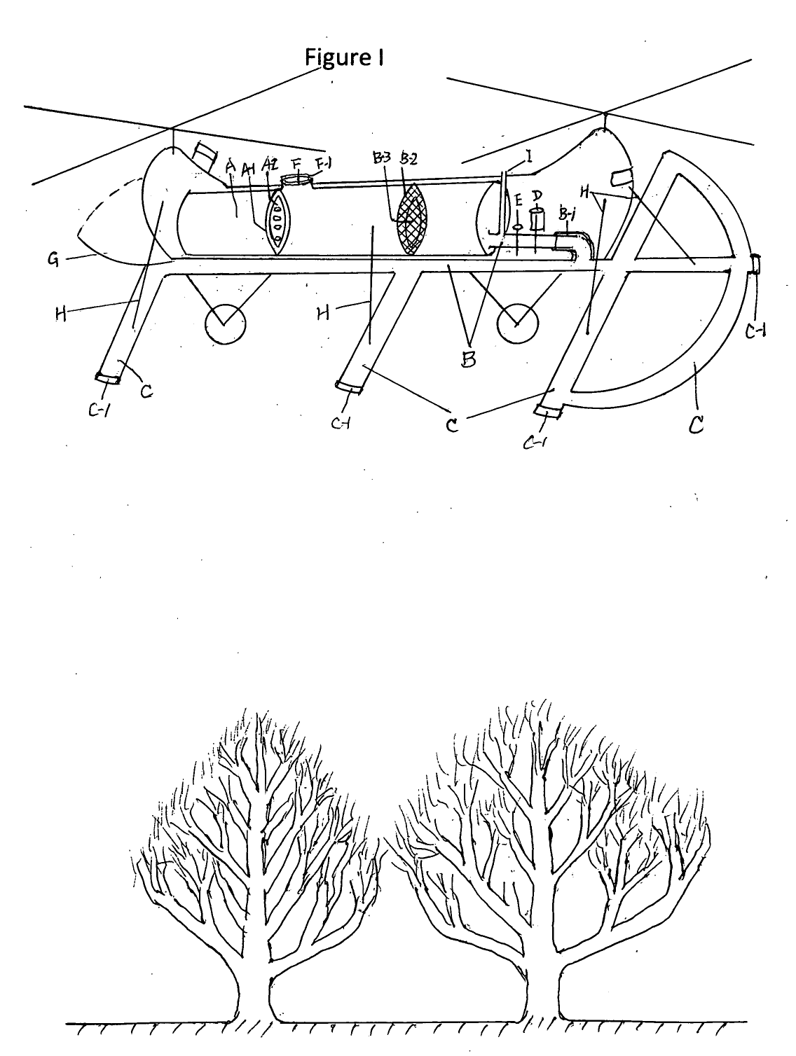

1. Forest fires mainly start from fuel on the forest floor such as leaves and branches with air in between them. Wind usually helps the fire, but rain combined with wind (V2) acts like a typhoon (±200 km per hour) and blows the fire from the fuel, freezing the place where fire started and the area surrounding the fire. This technique stops the production of carbon gas and the fire is ultimately extinguished (V1).
2. Action is easier than complicated theory. As Figure I shows, a super-size helicopter carries thousands of pounds of water. This time, the speed of moving toward fire depends on the speed of controlling the fire.
3. When the width of forest fire is wider than the width of the shower from the fire helicopter, two fire helicopters work together in parallel position showering the forest fire while at the same time keeping a safe distance. If two do not work, three, four, or more should be added (All the helicopters should work together simultaneously; multiple water sources should be faster than the increase of the speed of the fire).
For example, when playing a game of tug-of-war, five well-equipped players can overwhelm a team of five average players. Similarly, when controlling a forest fire, a super-sized helicopter with a precise showering system can outperform a typical fire-fighting helicopter. With a precise showering system and large holding tank, a super-sized helicopter can extinguish 10 meters of fire, while a typical helicopter can only extinguish 5 meters of fire at best.
4. If a fire helicopter pours heavy showers down onto the forest fire in a forward manner like in FIG. 1, this may interfere or stop the route of the forest fire. The heavy shower roles down the highway built in the dense forest after cutting trees down to make road, which further prevents forest fires from expanding. This method can isolate forest fire so we may use it before extinguishing the forest fire. Likewise, we may prevent from fire at houses in the forest using the same way.
5. The rain and wind (V2) soaks the leaves when they face the ground thereby preventing the fire from reoccurring, helping to control the fire.
6. When it is difficult to control the fire with water, fire chemicals may be used instead of water. Showering systems may help to control the fire when the water is spread evenly and over a wide area.

The Difference Between the Current Method of Controlling Forest Fires and the New Idea

The current method of controlling forest fires has been to pour water from the sky. The problem with the current method is that it is difficult to control forest fires in this way. In the proposed idea, fire helicopters would control the critical elements, “the rain and wind (V2)” to completely extinguish the forest fire. Fire helicopters may also put the fire out by monitoring the size of the forest fire by manipulating the freezing technique and monitoring a low altitude simultaneously. More importantly, the production of carbon gas from leaves and branches should stop (V1). For that, we should freeze the area of the fire. Low flight (V4) can hit the fire and helicopter can control freezing time with slow moving. By hitting the fire with “rain and wind” we may extinguish the forest fire.

The table below shows the difference between the old and new ways to control forest fires.

Difference between Old and New

| | Method | | |
|---|---|---|---|
| Activity | Old Way to control Forest Fires | New Idea to control Forest Fires | |
| Altitude | High Altitude | Low Altitude | |
| | The wind of fire helicopter does not | The wind of fire helicopter acts like | |
| | affect to forest fire. | typhoon blowing the fire away and | |
| | | freezing the area around the fire. | |
| Water | Waste | Efficient | |
| Use | The hit is sudden when water is poured | 1. | At a low altitude it is easier to |
| | from a high altitude. So freezing time is | | hit the mark and control the |
| | short and water cannot be distributed | | amount of water use. |
| | evenly. Moreover, water comes down | 2. | The shower system helps |
| | outside of the forest fire area. | | extinguish and freeze the fire |
| | | | area simultaneously because it |
| | | | distributes water evenly. |
| | | | Water can be catalyst for the |
| | | | better effect. |

| | | |
|---|---|---|
| Flight | Fast | Slow |
| Speed | It takes time to extinguish fire. When | 1. Flying at a low altitude is similar to |
| | water comes down from a high altitude, | moving in slow motion so it is easier |
| | it is hard to hit the mark because the | to hit the mark with the combination |
| | direction of wind may interfere, and | of water and wind generated from the |
| | time for freezing is lost. Not allowing for | helicopter (V2). In addition, visibility |
| | enough freezing time leaves carbon gas, | is better at a lower altitude so it is |
| | which can cause another fire to reoccur | easier to check whether a fire has |
| | in a nearby area. | been extinguished or not. |
| | | 2. Low altitude flying allows for |
| | | enough time to effectively freeze the |
| | | fire area. |

### Vocabulary in This Technical Disclosure

(V-1) Flame and Blaze: Numerous flames are called a ‘blaze’. In essence, forest fire is a type of gas. Forest fire is a chemical process between carbon gas, which is created by burning carbons found in leaves and branches, and oxygen in the air. The “rain and wind (V2)” technique can blow the fire away and freeze the area of ignition and around the fire. When this occurs, carbon gas is no longer produced.

(Experiment Example) When we blow out a candle, the candle goes out and we see white smoke; this is carbon gas. If we continuously blow out and freeze the wick with our breath, we can see the discontinuance of carbon gas production. To extinguish forest fires, the fire area should be effectively frozen so that carbon gas is not produced. By continuously freezing the area by this process, fire would not continue to spread.

Reference: Blazing forest fires produce carbon gas by heating up fuel left on the forest floor (i.e. leaves and branches). The production of carbon gas stimulates the blaze more and more. This interaction repeats itself as the fire gets bigger.

This interaction indicates that what we should stop production of carbon gas and the blaze while simultaneously extinguishing the forest fire. To make that happen, this new idea emphasizes that we make strong “rain and wind (V2)” and hit the forest fire with that. So the forest fire may be blown away and fire area frozen at the same time. Then carbon gas production would stop. Finally, through using all of these processes we can successfully control the forest fire.

(V-2) “Rain and Wind”: In this article, “rain and wind” refers to a typhoon-like rain. To create it, strong propeller wind from FIG. 1 is combined with water from the shower system of the fire helicopter.

When the fire is hit by a fire helicopter at low altitude (±300 m) for short time, the forest fire may be extinguished, that is, fire can be blown away and the fire area can be frozen at the same time. It takes a little bit of time to freeze a fire area.

When “rain and wind” is poured on the front side of the fire, the fire can be controlled. This acts like a highway separated in the two sides of a forest with removed trees. In this way we can protect houses and factories from the damage of the fire.

FIG. 1 shows how to make “rain and wind”
a. Control of the amount of shower water: Spinning speed of the water tap cork (E) and the motor (D) control the amount of water being used.
b. The streaks of rain: The holes of the shower head can be big or small (±16 inches). We can decide the proper size of the hole after experimenting. If we want a lot of streaks of rain or a wide range of distribution, we may add more shower holes or make them bigger.
c. Control of the wind: We can control the wind by flying at a low altitude (V4). When the fire helicopter is closer to the fire, the result of the wind contact with the fire is strong (wind velocity ±200 Km).

(V-3) Super Fire Helicopter: FIG. 1 (similar to a military transport plane). There are two large propellers in the front and back and it can carry thousands of pounds of water inside. It includes a connected shower system (B, C, D and E) and can hit the fire with “rain and wind” (V-2) at low altitude (V-4). The construction of the helicopter should be military grade because it must sustain its altitude and mobility within the strange air currents over the fire.

If it is allowed, using the plane as a water tank is suggested because more water can be kept in an extra tank. That being said, only the shower system would need to be added to super helicopter.

(V-4) Low Altitude: The closer to the ground, the stronger the wind, which then affects the forest fire like a typhoon. By controlling of the wind velocity the fire gets blown away. Low altitude so low flight means the degree of height which can reach to control the fire.

The altitude can change and this depends on the size of the forest fire, the degree of natural wind, and the weight of helicopter combined with the amount of water. Therefore the altitude must be controlled each time depending on the circumstances. The benefit of low altitude flight is that the fire helicopter can hit the exact area of the forest fire with “rain and wind,” and it is easy to check the state of fire and whether it has been extinguished.

(V-5) Forwarding Slow: “Forwarding Slow” means that the helicopter moves slowly forward. It takes more time to extinguish a fire when the blaze is strong than when the blaze is weak. To offer proper time to extinguish the fire we must take into account the strength of the blaze and regulate the speed of the helicopter between slow or fast. This kind of air speed regulation is known as “forwarding slow.” “Forwarding slow” allows for the time necessary to extinguish the fire. The speed of “forwarding slow” is decided depending on how fast the forest fire is being extinguished.

The five words above describe conditions which allow firefighters to extinguish forest fires and control the helicopter freely during normal flight. Blaze (V-1) is blown away by “the rain and wind” (V-2) thereby freezing the fire area. For this work, the “super fire helicopter” (V-3) carries thousands of pounds of water and distributes it while keeping low altitude (V-4) and a “forwarding slow (V-5)” motion. Like that normal flight can simply control fire fighting.

### FIGURE I DESCRIPTION

A—Water tank for temporary use
A1—Temporary partition to prevent waves in the water tank and supporter
A2—Opening like a door
B—Connection pipe between the water tank (A) and the showerhead (C): ±4 inch pipe
B1—Resilent rubber hose
B2—Wire net to filter influx (similar to shower head holes)
B3—Opening like a door
C—Shower pipe (±2.5 inch pipe),
Length: ±3 times longer than the length of the propeller, Holes for streaks of water: ± 1/16 inch holes (May decide after experiment.)
C1—Regular pipe cork (opens and closes while cleaning): Only when cleaning, it may be opened, otherwise, it will be closed all the time.
D—Motor to increase water pressure (on “B” pipe) commercial product
E—Automatic water open and close cork (on “B” pipe) commercial product
F—Water tank water inlet (±20 inch inlet): People need to get inside to clean up the tank.
F1—Lid of water tank
G—Back door: Use when inserting the water tank.
H—Resilient wire to support shower pipe.
The items listed above are commercially available products not inventions.

1. Condition to be the most efficient fire helicopter:
As shown in FIG. 1,
1) Super-size helicopters carry thousands of pounds of water.
2) The shower system (B, C, D and E) can be distributed like heavy rain.
3) The amount of water can be controlled freely and easily by use of a cork (E).
4) Fire helicopters make slow moving (V-5) and low altitude flight (V-4) easy.

2. The method of extinguishing fire:
1) The fire helicopter above comes down to the forest fire pouring water (with the shower systems-B, C, D and E).
2) When the light on the lower part of helicopter is turned off partly, it can stop coming down continuing the flight following the flow of forest fire and keeps a low altitude (±300 m).
3) Depending on the extinguishing speed, the helicopter continues to extinguish the forest fire by continuing its slow moving flight (V-5).
